(19) United States
(12) Patent Application Publication
(10) Pub. No.: US 2010/0212402 A1
(43) Pub. Date: Aug. 26, 2010

(54) Method and apparatus for precision non-destructive non-contact control of super small differences of pressure

(75) Inventors: Volodymyr I. Redko, Coral Springs, FL (US); Yurii V. Sokhach, Dnepropetrovsk (UA); Elena M. Shembel, Coral Springs, FL (US); Olexandr Kudrevatykh, Dnepropetrovsk (UA); Tymofiy V. Pastushkin, Ft. Lauderdale, FL (US); Vladimir Faustovich Rozhkovskyy, Dnepropetrovsk (UA); Oxana Red'ko, Dnepropetrovsk (UA)

Correspondence Address: Enerize Corporation, 4956 Rothschild Dr., Coral Springs, FL, 33067-4134, US

(73) Assignee: Enerize Corporation, Coral Springs, FL (US)

(21) Appl. No.: 12/658,830

(22) Filed: Feb. 16, 2010

Related U.S. Application Data
(60) Provisional application No. 61/207,536, filed on Feb. 14, 2009.

(51) Int. Cl. G01N 7/00; G01N 21/41

(52) U.S. Cl. 73/31.04; 356/128

(57) ABSTRACT

Method and apparatus for precision non-destructive non-contact control of super small differences of pressure, which is used for non-destructive control of tightness of various products regardless of the method of sealing and the state of the internal volume of products, with the apparatus consisting of a body of the control unit of the device, working and control units, sensitive membrane, transparent window of the control unit, connecting pipes of the control and working chambers, electronic speckle interferometer, the base that is isolated from the vibration, and the electronic processing unit for monitoring results and presenting results on the display. The bending of the membrane characterizes the quality of sealing of the investigated object and is determined by the laser method of non-contact electronic speckle interferometry.

### CROSS-REFERENCE TO RELATED APPLICATIONS

This application incorporates by reference in its entirety and claims priority to Provisional Patent Application No. 61/207,536, filing date Feb. 14, 2009

### FEDERALLY SPONSORED RESEARCH

None

### SEQUENCE LISTING

None

### FIELD OF THE INVENTION

The invention relates to the field of non-contact non-destructive physical methods to control the airtightness of large and small vessels or containers, for example for testing in the manufacturing process and after the installation of autonomous current sources, such as batteries, supercapacitors, fuel cells, as well as in food industry and other industries. The invention can be used in the manufacture of any objects where the sensitive control of the airtightness of the closed containers is necessary.

### BACKGROUND OF THE INVENTION

Method of controlling airtightness refers to the means of measuring small values of gas pressure. To determine the degree of airtightness of containers the method of measuring changes in pressure was used.

To measure the pressure the various methods which are based on the using of the membrane are used. These methods are fundamentally different by the structure of the membrane and by the method of recording the movement of the membrane under the effect of changing pressure. The sensitivity and range of pressure, for the way which is used to control the pressure, depend on the design of the membrane and the method of recording the parameters.

There is a known diaphragm pressure gauge measuring pressure, which consists of a sealed enclosure, a membrane of molybdenum permalloy soldered to it, and two electric coils with cores. Under the influence of the measured pressure, the bending of the membrane occurs. Consequently, the magnetic resistance of one coil reduces, and the magnetic resistance of the other coil increases. By change in the magnetic resistance of the electrical coils one determines the corresponding change in pressure applied to the membrane. In this gauge the membrane has a thickness of about 0.03 mm. Bending stiffness of the membrane allows to measure the pressure of 15 Pa and more.

A disadvantage of this gauge is a high threshold pressure, for example, when using it to determine the degree of airtightness of products of different sizes

The closest prototype in essential features is a diaphragm pressure gauge measuring the low-pressure, which consists of a sealed enclosure, internal volume of which is divided into two elastic membrane volume, and a capacitive-type transducer of a Baratron type. Under the influence of the measured pressure, the bending of the membrane occurs.

Because of the bending of the membrane the electrical capacitance of the inductive transducer changes. By changing the numerical value of electric capacitance one can determine the value of the measured pressure.

This gauge has a much lower threshold of measurement sensitivity as compared with the known gauges and allows to measure the pressure of 0.77×10⁻² Pa. However, this measurement sensitivity is insufficient when using membrane sensors to determine the degree of leakage in tanks when faulty sealing is caused by the lack of penetration in the body sizes of products and the lack of penetration is several tens of microns.

The sensitivity of the manometer depends on the rigidity of the membrane. The main reason, which does not allow to considerably reduce the threshold of sensitivity of measurement of membrane manometers, is the use of membranes, which have certain bending stiffness. The value of the rigidity of the membrane in these gauges must meet the following requirements: the deflection of the membrane must change when the pressure changes, and the deflection of the membrane must provide propulsion measurement sensors that characterize the deflection of the membrane.

The method claimed in this invention is based on the goal to improve the characteristics of the method and apparatus for measuring small changes in pressure, namely, lowering the threshold sensitivity of measurements

This goal is reached by using non-contact method of electronic speckle interferometry as a sensing element.

Designed in the present invention diaphragm pressure gauge for measuring small pressure consists of a tight control block, which internal volume is divided by the elastic membrane into two volumes: working volume and control volume. The membrane is made of special material with super-low bending rigidity, and one of the walls of the shell is made optically transparent. The super-low overpressure in one of the volumes is determined by the curvature of the membrane using a laser non-contact method of electronic speckle interferometry.

### BRIEF SUMMARY OF THE INVENTION

To control the leakage of large and small volumes within a sealed enclosure control unit the initial pressure with the use of any gas is created. The gas pressure is evenly distributed between the working and the control chambers of the block by using a T-tube. The membrane will have a zero deflection, i.e. the deflection of the membrane will be absent. Initial position of the membrane is fixed with an electronic speckle interferometry. After this the valve of the gas flow closes and the deflection of the membrane over time is recorded by using electronic speckle interferometry.

The presence of depression would indicate a change in pressure in one cell versus another due to the fact of leaks in the test object. According to the dynamics of growth depression one can judge the magnitude of changes in the pressure differential, or the extent of leaks in the test object.

The vacuum method is applied to control the airtightness of products of small volumes, such as current sources. An object of a small volume, such as a battery or supercapacitor, filled with the electrolyte to the normal pressure and sealed in any way, is placed in the working chamber. Then air is pumped to a certain value from the working and reference chambers of the control unit.

Then the valves are closed. The initial state of the membrane is fixed by electronic speckle interferometry method. In case of leakage of the controlled object, the electrolyte from the bulk of the current source or supercapacitor through defects in the sealing layer flows into the working chamber of the device. The pressure in the chamber changes. The membrane gradually changes its deflection as the electrolytes flows and the pressure in the chamber changes.

Change in the deflection of the membrane indicates the presence of leakage, i.e. defect in the controlled object. The measurement results are recorded by apparatus on the liquid crystal display. The steepness of a graph of the numerical values of the deflection of the membrane over time indicates on the magnitude of leakage of controlled products.

When using a current source, for example during discharge or charge of lithium current sources, the formation of gas in the inner volume of the current source may occur. This happens due to the occurrence of side electrochemical and chemical reactions. Because of the formation of gas the current source volume may increase. Gas formation within the current source at its cycling is dangerous from the standpoint of the working conditions of the current source. Gas formation in the current source can lead to loss of contact within the current source due to filling of the pores of the separator with gas, blocking the working electrode surface with gas; short circuit due to mechanical pressure of the gas onto components of the electronic structure. Therefore it is very important to study and monitor the process of the gas formation inside the current source.

A preliminary vacuumization of working and control chambers is not applied for the measurements in this case. If the gas is forming inside the current source then the volume of the current source increases. The internal pressure in the working chamber of the measuring device increases as compared with the pressure in the control chamber. Respectively, the deflection of the sensitive membrane changes. Change in the deflection is recorded with a laser beam by electronic speckle interferometry method. Measurement results will indicate the flow of secondary processes in the current source, i.e. defects in the current source.

### DESCRIPTION OF THE DRAWINGS

FIG. 1 illustrates the apparatus for precision non-destructive control of super-low pressure changes in the objects of small dimensions, where 101—frame of control unit of the device, 102—sensitive membrane, 103—transparent window of control unit, 104—socket of the working chamber, 105—socket of the control chamber, 106—control chamber; 107—electronic speckle interferometer, 108—the base of the device protected from vibration; 109—working chamber; 110—electronic unit of analysis, processing and presentation to display of the monitoring results, 111—tee to equalize pressure in the working and control chambers; 112—valve of control chamber, 113—valve of working chamber; 114—a current source, such as lithium battery; 115—load resistance for current source; 116—pump.

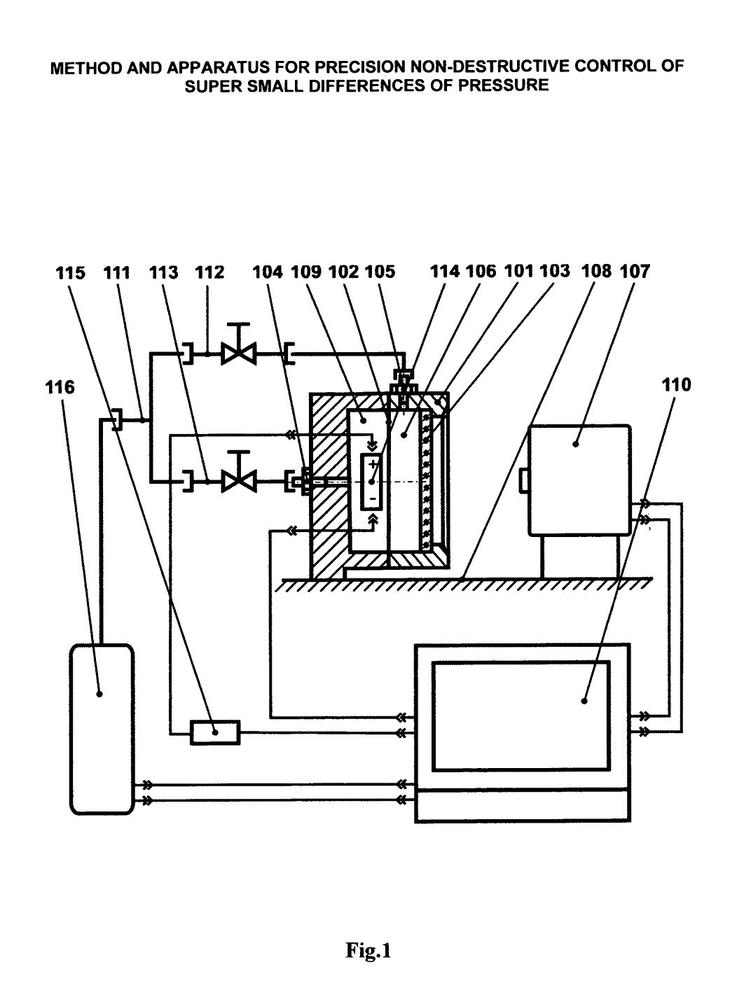

FIG. 2. illustrates the calculated graph of the threshold sensitivity of the instrument depending on the thickness of the membrane, where H-thickness of the membrane, the membrane radius R=35 mm, the rubber membrane with a modulus of elasticity of the first kind σ=0.49 MPa; modulus of elasticity of the second kind E=2.1 MPa.

FIG. 3 illustrates the calculated graph of the threshold sensitivity of the instrument depending on the radius of the membrane, where R is the radius of the membrane, the membrane thickness H=0.05 mm, the membrane is from rubber with σ=0.49 MPa; gas pressure E=2.1 MPa.

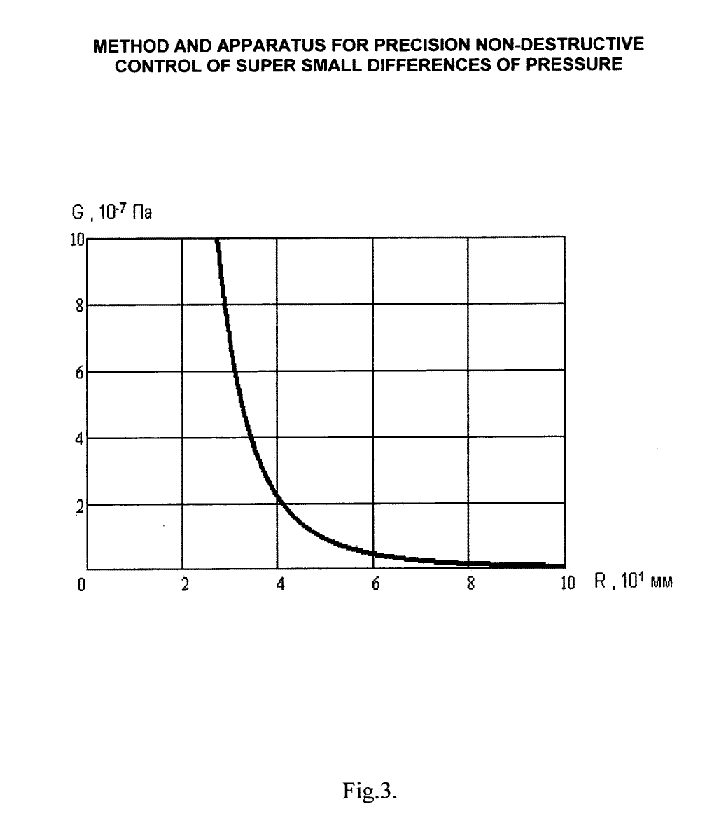

FIG. 4 presents the experimental model of the developed apparatus, where 401—control box of the apparatus, 402—electronic speckle interferometer, 403—the base of the device protected from vibration.

### DETAILED DESCRIPTION OF THE INVENTION

Non-destructive method for detection of super-low pressure changes is one of the most promising and effective methods with high sensitivity for non-contact detection of industrial leak sealed containers in a manual or automatic mode.

The implementation of the invention includes the following steps, which depend on dimensions of the controlled object.

In case of large volumes of the objects, for example, a fuel tank of a missile:
The working and control chambers of the device are connected to the test object through the sleeve connects,
The object is pumped with gas to a certain, safe for the object, initial pressure,
Using a tee in the controlled facility, the pressure in the working and control cells is set equal.
The valve of the control chamber is closed and due to this the pressure in the control chamber is kept unchanged throughout the entire test.
In the beginning, due to the equality of pressures in the volume of the controlled object and in the two chambers, the deflection of the membrane will be equal to zero, which is recorded by electronic unit of the device,
In a certain period of time the deflection of the membrane is fixed again,
If the deflection of the membrane is different from zero, this means that the object has a defect through which gas leaks.

For the case of small-sized object, such as a lithium current source:
Compact object is placed inside the working chamber of the control unit,
Working and control chamber are vacuumized to the same pressure with the tee.
Then control chamber is cut off from the working chamber with the valve of the control chamber.
After this both chambers are separately sealed.
Initial (zero) deflection of the membrane is fixed with the electronic control unit of the device.
In a fixed period of time the deflection of the membrane is fixed again.
If the object has hidden defects (faulty sealing or increase in pressure due to adverse reactions or other defects) then the initial deflection of the membrane will be altered.
Presence of a nonzero deflection will indicate the presence of a latent defect in the controlled object, and the amount of deflection will reflect the degree of leakage.
If the deflection remained zero then the controlled object is sealed and has no leakage.

### Example 1

According to the theory of elasticity for a circular membrane the value of the maximum deflection W is related with the applied on the membrane uniformly distributed pressure P by the following equation:

$$w = \frac{{PR}^{4}}{64 D} ,$$

where the cylindrical rigidity D is defined by:

$$D = \frac{{Eh}^{3}}{12 ( 1 - {σ}^{2} )} ,$$

and E, σ—modulus of elasticity of the first and second kind, respectively. Thus, the following ratio is introduced in the electronic circuit apparatus for calculating the deflection from the parameters of the membrane and the pressure

$$W = \frac{{PR}^{4} ( 1 - {σ}^{2} )}{5.3 {DE h}^{3}} ;$$

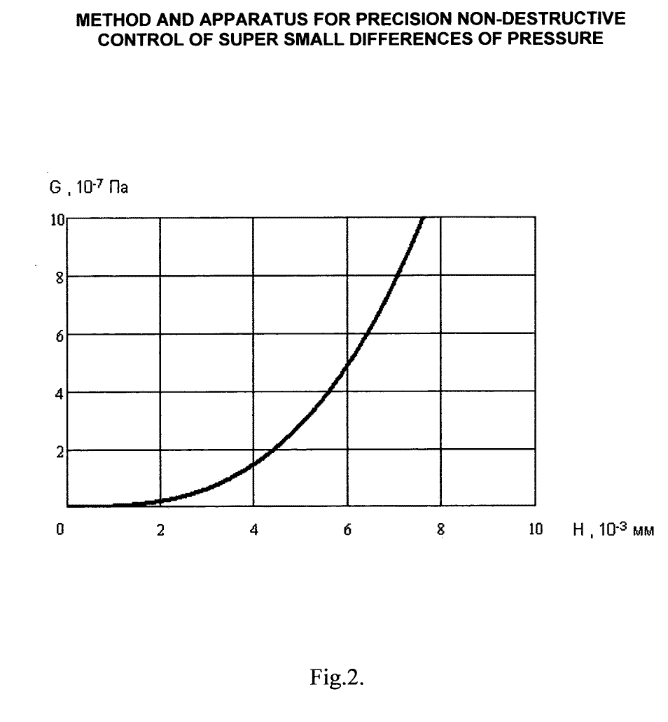

By using these formulas the corresponding graphs (FIG. 2, 3), which characterize the capability of the equipment, are constructed.

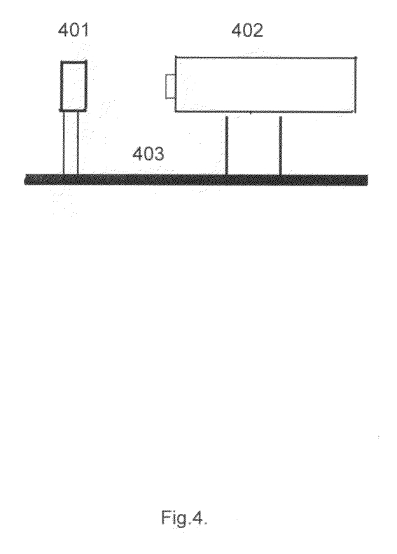

The developed method is implemented in the fabricated device (FIG. 4). The device is installed with a thin membrane with the following parameters: H=0.05mm, R=35 mm, σ=0.49, E=2.1 MPa. A laser with a wavelength X=0.632 micron was used as an emitter. The threshold G=1.3×10⁻⁹ Pa was experimentally achieved, which is seven orders of magnitude smaller than that of the prototype.

### Example 2

A controlled container is tightly connected with the fitting of the working chamber. For example, a package for hermetic packaging of any item. Neutral gas is injected through the tee in the combined volume to obtain the initial pressure inside this volume. With the help of the valve of the control chamber its volume is cut off from the volume of working chamber and from the controlled object. Using electronic speckle interferometer through a transparent window of the device the initial bending of the membrane is recorded and transferred to the memory of the measuring apparatus.

After a fixed period of time the bending of the membrane device is fixed by fixed electronic speckle interferometer. The data are analyzed by the measuring unit using a special program and the conclusion about controlled tank is issued.

### Example 3

A controlled object is placed inside the working chamber of the device. It is assumed that the internal volume of the object is sealed from the outside environment or has some internal overpressure. Vacuum load with the predetermined calculated value is supplied using a vacuum pump through the tee in the working and control chambers, providing the flow of its contents from the inner cavity of the controlled object (for example, the electrolyte from the current source) in case of the presence of a latent defect. Then the control chamber cut off from the working chamber by the valve.

Initial position of the sensitive membrane is detected by electronic speckle interferometer and transferred to the memory of the measuring equipment. After a fixed period of time position of the sensitive membrane is detected by electronic speckle interferometer and transferred to the memory of the measuring apparatus. The bending data are analyzed in the apparatus using a special program and the conclusion about the sealing quality of the controlled products is issued.

### Example 4

In this example, we detect a broken balance of components in a multi component system of the power sources or the side processes in power sources. For non-destructive control of this parameter the output connections with a battery, for example Li-ion battery or supercapacitor are processed through the sleeve of the working chamber.

All sockets of the equipment are sealed. Initial position of the sensitive membrane is detected by speckle interferometer and transferred to the computer memory. Then the current source is connected to the load and begins to be discharged or cycled in the discharge—charge mode. After a partial discharge of the current source, if its components are not balanced the gas will be formed in its volume. As a result, the volume of the current source increases. This would increase the pressure in the working chamber of the device and would result in additional bending of the sensitive membrane.

After a certain period of time the final position of the sensitive membrane is detected by electronic speckle interferometer and transferred to the memory unit of the information processing block. The bending data are analyzed in the apparatus using a special program and the conclusion about the quality of the controlled facility is shown on the display.

### CLOSURE

While various embodiments of the present invention have been shown and described, it will be apparent to those skilled in the art that many changes and modifications may be made without departing from the invention in its broader aspects. The appended claims are therefore intended to cover all such changes and modifications as fall within the true spirit and scope of the invention.

We claim:

1. Method for non-destructive non-contact precision control of the super small changes in pressure, that includes:
hermetic connection of the investigated object to the working chamber; or
introduction of the investigated object inside the working chamber;
fixing of the initial position of the measuring membrane, which is located between the working and control chambers due to changes of internal pressure in the working chamber;
fixing of the altered state of the membrane that is measured;
a comparative analysis of the status of the membrane that is measured;
issuance of the conclusion about the airairtightness of the controlled object;
while fixing of the position of the measured membrane is carried our by joint usage of the laser and electron speckle interferometer and the process of the fixing of the membrane position is carried our through a transparent window in the working chamber .

2. The method as in claim 1, wherein the investigated object is hermetically connected with the working chamber of the measuring device and and through the sleeve of the working chamber a positive pressure is created inside of the controlled object to ensure initial bending of the measuring membrane.

3. The method as in claim 1, wherein the investigated object is hermetically connected with the working chamber of the measuring device and through the sleeve of the working chamber a vacuum is created inside of the controlled object to ensure initial bending of the measuring membrane.

4. The method as in claim 1, wherein the investigated object is introduced into the working chamber and through the sleeve of the working chamber a positive pressure is created to ensure initial bending of the measuring membrane.

5. The method as in claim 1, wherein the investigated object is introduced into the working chamber and through the sleeve of the working chamber a vacuum is created to ensure initial bending of the measuring membrane.

6. The method as in claim 1, wherein at the time of the termination of pressure changes in the working chamber in accordance with the program controlling the equipment the laser and electronic speckle interferometer are turned on and the initial bending of the sensitive membrane is detected through a transparent window and its image is transferred to the memory of the apparatus.

7. The method as in claim 1, wherein a pause in time before the next cycle of measurements is introduced, calculated in accordance with the level of airtightness of the controlled object, during which the working chamber pressure either changes or remains unchanged.

8. The method as in claim 1, wherein after a pause in time, which is predetermined experimentally for each type of object and entered into the managing program of the equipment, a laser generator and electronic speckle interferometer are turned on and the final bend of the sensitive membrane is detected through a transparent window in the chamber recorded and its image is transferred to the memory of the measuring apparatus.

9. The method as in claim 1, wherein the equipment processes the measured parameters taking into account the calculated values of allowable defects, excessive pressure or vacuum, and a temporary pause, and a special analysis program issues a conclusion about the object under control.

10. Apparatus for non-destructive precision control of super small pressure drops, which consists of:
Sealed enclosure, which internal volume is divided into two chambers, working and control, between which the elastic membrane is positioned, with the working and control cameras equipped with connecting pipes and valves.
Special vibroinsulated foundation.
Measuring unit, which consists of laser and electronic speckle interferometer and electronic unit for processing and displaying results of the control.

11. Apparatus as in claim 10, wherein the measuring membrane with the thickness not exceeding 0.05 micron is made of material with small cylindrical stiffness.

12. Apparatus as in claim 10, wherein the measuring membrane is made of material with cylindrical stiffness not exceeding 3.0×10⁻⁸ [Newton×meter].

13. Apparatus as in claim 10, wherein the wall of sealed enclosure, addressed to the measuring unit, is made optically transparent with zero coefficient of light refraction.
